(19) United States
(12) Patent Application Publication
(10) Pub. No.: US 2007/0260507 A1
(43) Pub. Date: Nov. 8, 2007

(54) Automatically creating promotional funds

(76) Inventors: Yee-Ann Lee, Fremont, CA (US); Rahul Viswanathan, Fremont, CA (US); Jun Gao, Emeryville, CA (US); Rajani Yelkur, Fremont, CA (US)

Correspondence Address: CAMPBELL STEPHENSON LLP, 11401 CENTURY OAKS TERRACE, BLDG. H, SUITE 250, AUSTIN, TX, 78758, US

(21) Appl. No.: 10/185,938

(22) Filed: Jun. 27, 2002

Related U.S. Application Data
(60) Provisional application No. 60/383,314, filed on May 24, 2002.

(51) Int. Cl. G06Q 30/00; G06Q 40/00

(52) U.S. Cl. 705/14; 705/39

(57) ABSTRACT

A facility for creating promotional funds for a purveyor of consumer goods is described. The facility receives user input specifying fund attributes to be shared by promotional funds to be created. For each of a plurality of accounts of the purveyor, the facility creates a promotional fund having the specified attributes.

### RELATED APPLICATIONS

This application claims the benefit of provisional U.S. Patent Application No. 60/383,314, filed May 24, 2002, which is hereby incorporated by reference in its entirety.

### TECHNICAL FIELD

The present invention is directed to the field of vertical software solutions targeted to the consumer goods industry and related industries.

### BACKGROUND

In consumer goods industries, many manufacturers of goods (“manufacturers”) benefit by fostering strong relationships with the retailers that sell their goods to consumers. As one component of fostering such strong relationships, many manufacturers maintain promotional funds for some or all of their retailers. Where a promotional fund is maintained by a particular manufacturer for a particular retailer, the retailer may use money residing in its promotional fund for approved promotional activities for the manufacturer's products. For example, the retailer may use money residing in the promotional fund to pay for an advertising campaign for one of the manufacturer's products, or to pay for a temporary price reduction for one of the manufacturer's products. Promotional funds are also variously referred to as “trade funds,” or simply “funds.”

A large manufacturer may have thousands of retailers, and may need to maintain ten or more different promotional funds for each retailer, each for a different product or group of products manufactured by the manufacturer. In view of the substantial cost of maintaining such a large number of promotional funds manually, such a manufacturer may realize significant efficiencies by using a software application to manage its promotional funds.

Conventional software applications used by manufacturers to manage their promotional funds typically provide a user interface for individually creating promotional funds. For example, a user using such a user interface may enter 10-20 different data attributes of a promotional fund in order to create the promotional fund. Manual data entry on such a large scale has several disadvantages: it can be time-consuming, expensive, and error-prone.

In some cases, manufacturers using a software application to manage their promotional funds have circumvented the need for such large-scale manual data entry by developing special-purpose, custom computer programs for generating data defining all of their promotional funds, and importing the generated data into the software application for use by the software application. Such custom programs can be difficult to develop, however, often requiring specialized expertise. In addition, such custom programs are typically unable to leverage the data already stored by the application program about the manufacturer, its products, and its existing promotional funds. Because such custom programs are separate from the application program, users of such custom programs often face data synchronization errors and higher maintenance costs.

In view of the above-described disadvantages of conventional approaches to creating promotional funds for use in a software application for managing promotional funds, an improved approach for creating promotional funds within the software application that minimized the amount of manual data entry required would have significant utility.

### BRIEF DESCRIPTION OF THE DRAWINGS

FIG. 1 is a block diagram showing some of the components typically incorporated in at least some of the computer systems and other devices on which the facility executes.

FIG. 2 is a display diagram showing a sample user interface typically presented by the facility.

FIG. 3 is a display diagram showing the creation of a new fund group.

FIG. 4 is a display diagram showing the addition of target products to the example fund group.

FIG. 5 is a display diagram showing the automatic population of the Target Products window with products in the target category specified for the fund group.

FIG. 6 is a display diagram showing a typical user interface presented by the facility for selecting accounts for the example fund group.

FIG. 7 is a display diagram showing the results of selecting accounts for the example fund group.

FIG. 8 is a display diagram showing the entry of individual fund attributes for the example fund group.

FIG. 9 is a display diagram showing funds automatically generated by the facility.

FIG. 10 is a display diagram showing additional detail on one of the created funds.

FIG. 11 is a display diagram showing the creation of a fund group comprised of accrual funds.

FIG. 12 is a display diagram showing the selection of source products for the example fund group of accrual funds.

FIG. 13 is a display diagram showing source products for the accrual example fund group automatically populated from the source category specified for this fund group.

FIG. 14 is a display diagram showing the generation of sample accrual funds using the example accrual fund group.

FIG. 15 is a display diagram showing additional detail on one of the created accrual funds.

FIG. 16 is a display diagram showing additional details about the accrual of money in sample accrual funds.

FIG. 17 is a flow diagram showing steps typically performed by the facility in order to create a number of new promotional funds.

FIG. 18 is a flow diagram showing steps typically performed by the facility in order to display a list of products that includes the products comprising a user-selected product category.

FIG. 19 is a data structure diagram showing a sample product categorization tree used by the facility to populate the target products window 540 with rows 543 based upon the user's selection of the Ace Splash category as the target category for the example fund group.

### DETAILED DESCRIPTION

A software facility for automatically creating promotional funds (“the facility”) is provided. Embodiments of the facility allow a user of a software application for managing promotional funds to simultaneously create a large number of promotional funds within the application by providing a minimum of user input.

In some embodiments, the facility enables the user to create a fund group that will be used to create a large number of individual promotional funds. As part of creating a fund group, a user uses a user interface provided the facility to specify a list of retailers or other accounts, such that the facility will create a single fund for each specified account. The user further uses a user interface provided the facility to specify a set of shared fund attributes that will be attributed to all promotional funds created as part of the fund group, such as a category or set of target products to which money in the funds of the fund group may be applied. Also, if desired, the user further uses a user interface provided the facility to specify individual fund attributes to be attributed to particular individual promotional funds, such as percentages of a total fund group budget to be allocated to each promotional fund. Once the user has specified the various aspects of the fund group, the facility uses the fund group to automatically generate the specified funds for administration within in the software application. Embodiments of the facility can create fixed funds in which an initial budget for each fund is established when the funds are created, accrual funds in which each fund accrues money over its effective period based upon activities of its account, both fixed and accrual funds, and/or hybrids of fixed and accrual funds.

In some embodiments, the facility further assists the user in specifying lists of products—such as of target products to which money in the funds may be applied and source products whose sale causes money to accrue in accrual accounts—by automatically enumerating the products falling within a product category selected by the user. Such enumeration typically includes products that are directly present in the selected category, as well as those in subcategories, sub-subcategories, etc. of the selected category.

By creating promotional funds in the ways described above, embodiments of the facility enable a user to quickly and straightforwardly create a large number of promotional funds in a way that significantly reduces the likelihood of including inaccurate data in the created promotional funds and obviates the development of a special-purpose program to create promotional funds.

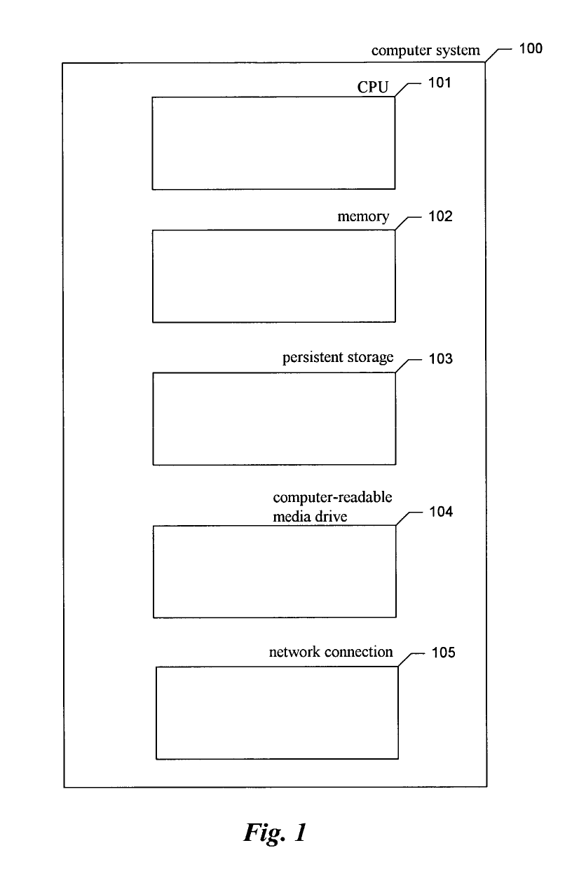

FIG. 1 is a block diagram showing some of the components typically incorporated in at least some of the computer systems and other devices on which the facility executes. These computer systems and devices 100 may include one or more central processing units (“CPUs”) 101 for executing computer programs; a computer memory 102 for storing programs and data—including data structures—while they are being used; a persistent storage device 103, such as a hard drive, for persistently storing programs and data; a computer-readable media drive 104, such as a CD-ROM drive, for reading programs and data stored on a computer-readable medium; and a network connection 105 for connecting the computer system to other computer systems, such as via the Internet, to exchange programs and/or data—including data structures. While computer systems configured as described above are typically used to support the operation of the facility, one of ordinary skill in the art will appreciate that the facility may be implemented using devices of various types and configurations, and having various components.

In the discussion that follows, embodiments of the facility are described in conjunction with a variety of illustrative examples.

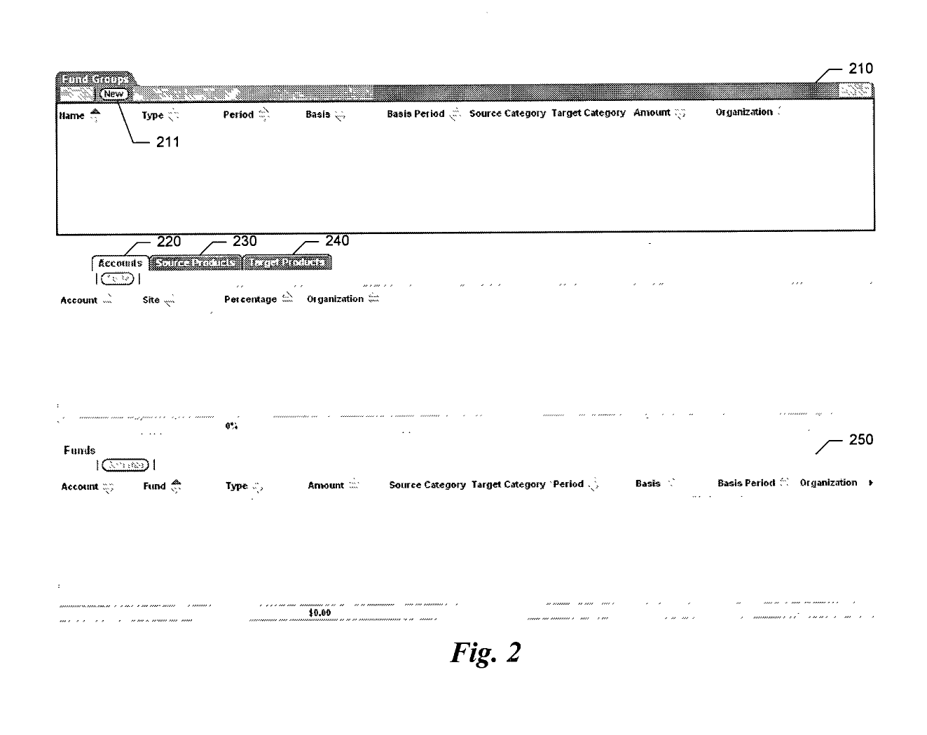

FIG. 2 is a display diagram showing a sample user interface typically presented by the facility. It includes a Fund Groups window 210 listing fund groups created by the user; an Accounts window 220, shown here to be fully displayed, listing accounts selected by the user for generating funds in a fund group selected in the Funds window; a Source Products window 230 and a Target Products window 240, here both shown to be obscured, listing fund attributes specified by the user for the currently-selected fund group for attribution to all of the funds created in the selected fund group; and a Funds window 250 listing the funds of a currently-selected fund group once they have been created using the facility.

The user begins the process of creating a set of new funds by creating a fund group to represent the set of funds to be created. A fund group may be thought of as a template used by the facility to automatically create funds. To initiate this process, the user clicks a New button 211 in the Fund Groups window 210.

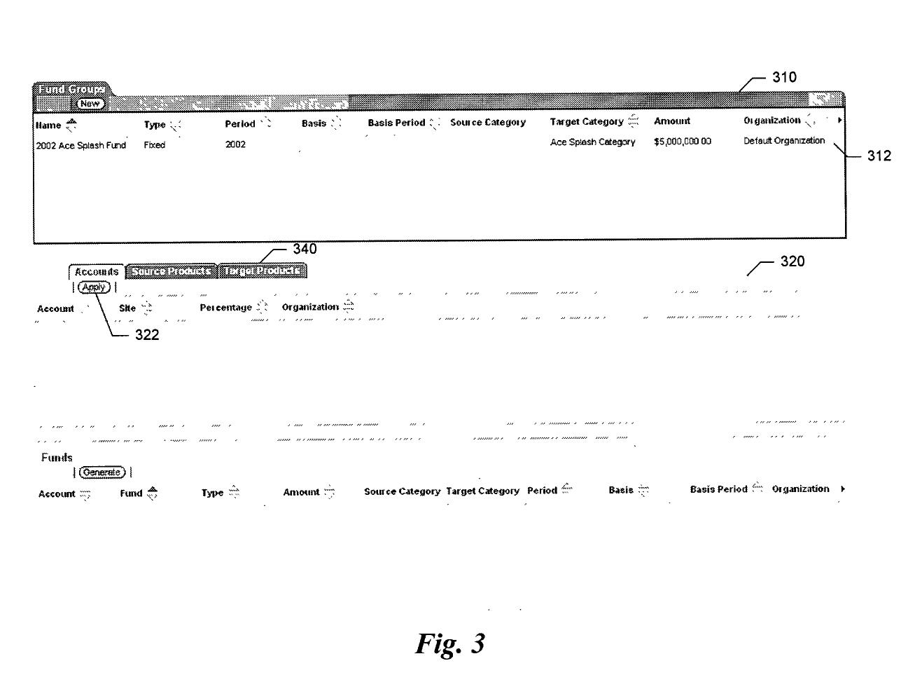

FIG. 3 is a display diagram showing the creation of a new fund group. Information entered in the fund group will be propagated directly to the auto-generated funds or otherwise used by the facility during the auto-generation process. It can be seen that, by clicking on button 211 and subsequently entering prompted-for information, the user has created row 312 representing the created fund group in the Fund Groups window 310. For the example fund group shown in FIG. 3, the user enters the information shown below in Table 1:

TABLE 1
Type - the type of fund group. In this example, the user selects ‘Fixed’ to
specify that the auto-generated funds will be populated with a beginning
amount.
Period - the period over which the auto-generated funds is active. In this
example, the user selects ‘2002’
Target Category - the category of products for which the auto-generated
funds can be used for. In this example, the user selects ‘Ace Splash
Category’.
Amount - the amount to be allocated across the retailers to be added in a
later step. In this example, the user enters ‘$5,000,000’.
Organization - the organization to which the auto-generated funds belong.
In this example, the user selects ‘Default Organization’.

The user next adds target products to the fund group. This process is linked to the target category the user previously selected for the fund group. To navigate to the view where target products are added, the user clicks on the tab for the Target Products window 340.

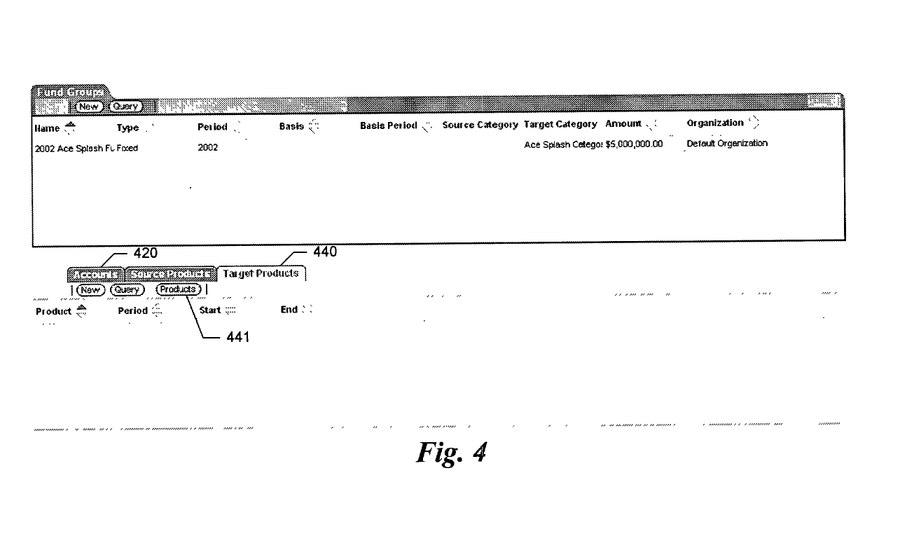

FIG. 4 is a display diagram showing the addition of target products to the example fund group. In FIG. 4, Target Products window 440 is shown to be fully displayed. In order to populate the Target Products window 440 with all of the products in the Ace Splash category specified as the target category for the example fund group, the user clicks a Products button 441 in the Target Products window 440. The facility adds target products automatically by identifying all products that belong to the target category of the fund group. Specifically, the facility automatically adds all the products which belong to the target category and all products that belong to sub-categories of the target category. The facility can traverse an n-tier hierarchy to identify and add target products. Additionally, the user can also manually add one or more target products. The facility ensures that duplicate products are not added.

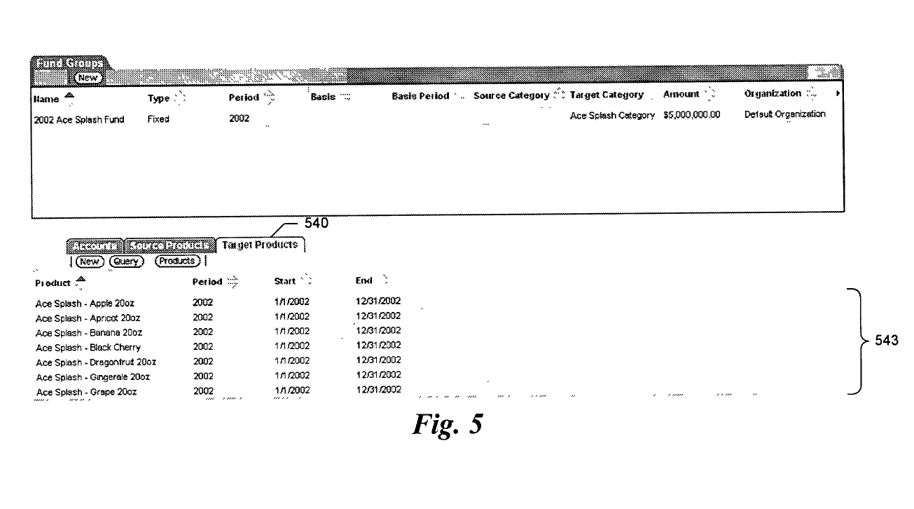

FIG. 5 is a display diagram showing the automatic population of the Target Products window with products in the target category specified for the fund group. Here it can be seen that rows 543, corresponding to products in the Ace Splash product category specified as the target category for the example fund group, have been added to the Target Products window 540.

The user next adds retailers to the fund group. The retailers added will be assigned funds created with fund auto-generation. To navigate to the view where retailers are added, the user clicks on the tab for the Accounts window 420.

In response to the user clicking the tab for the Accounts window, the facility again presents the display shown in FIG. 3. At this point, the user clicks an Apply button 322 in the Accounts window 320 in order to select accounts for which funds will be generated within the fund group.

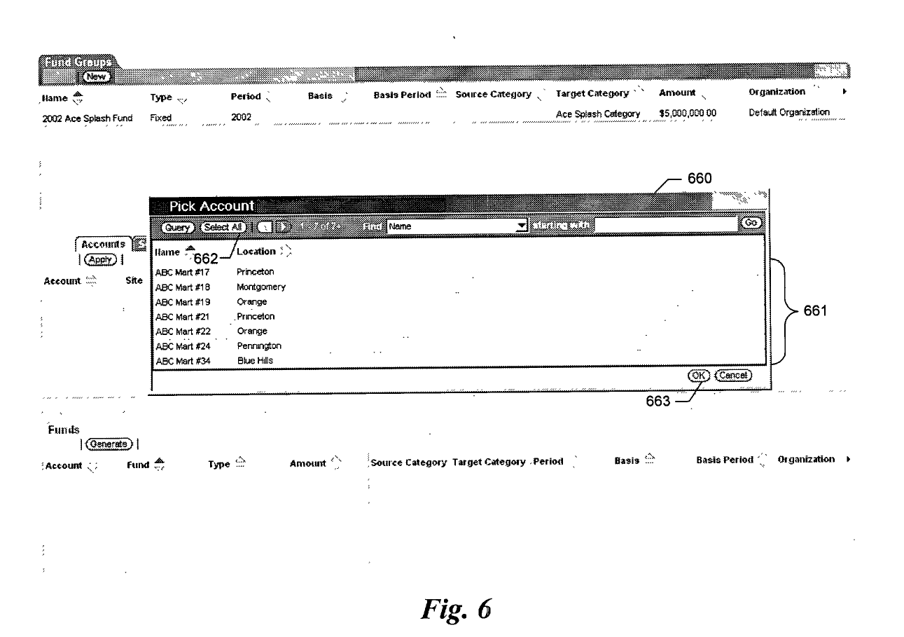

FIG. 6 is a display diagram showing a typical user interface presented by the facility for selecting accounts for the example fund group. The facility displays pop-up window 660, in which are listed rows 661 each containing the name and location of one of the manufacturer's retailers or other accounts. In the pop-up window, the user selects the accounts that should be added to the fund group. In the example, rather than individually selecting accounts, the user clicks a Select All button 662 in order to select all of the listed accounts. The user then clicks an OK button 663 to accept the selected accounts.

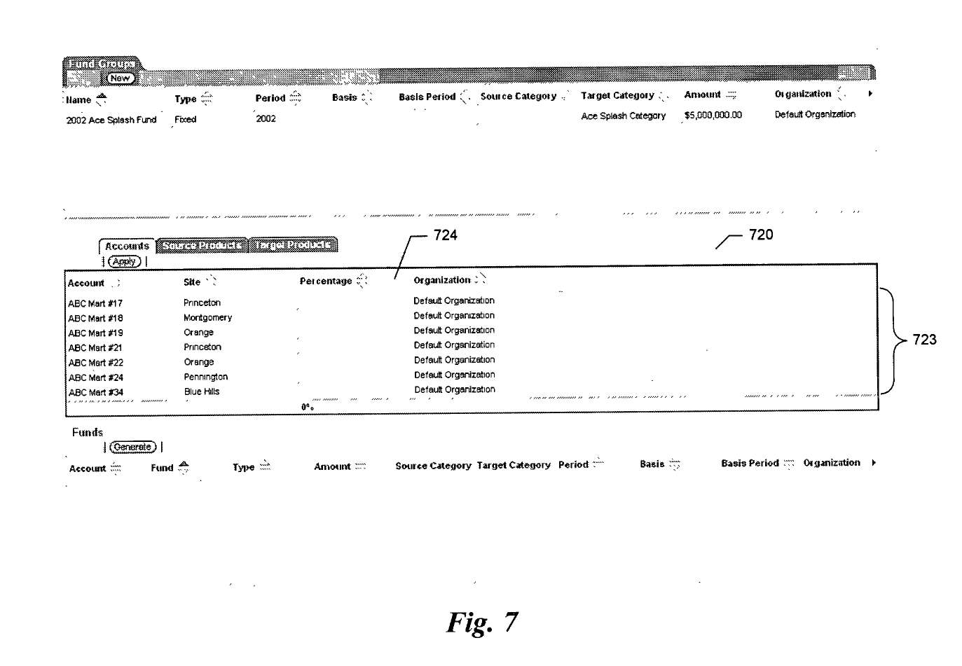

FIG. 7 is a display diagram showing the results of selecting accounts for the example fund group. It can be seen that rows 723, corresponding to accounts selected in pop-up window 660, have been added to the Accounts window 720. After the accounts are added to the fund group, the user may use the Accounts window 720 to specify individual fund attributes for the funds that will created for particular accounts. For example, the user may enter the percentage of a total fund group budget to be allocated to each of the accounts 723 by entering this percentage in column 724.

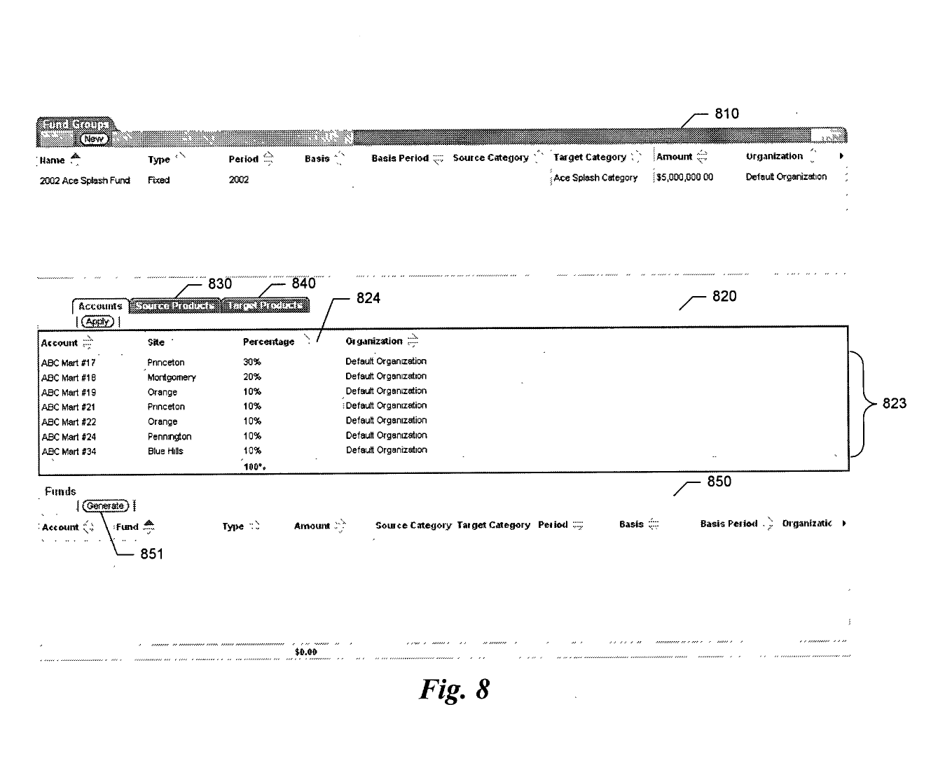

FIG. 8 is a display diagram showing the entry of individual fund attributes for the example fund group. It can be seen that the user has entered percentages in column 824 of the rows 823. These percentages will be used along with the total amount entered for the fund group in order to determine how much money each auto-generated fund contains immediately after being auto-generated.

In order to automatically generate funds in the example fund group for each of the accounts selected in the Accounts window 820 having shared attributes selected in the Fund Groups window 810, the Source Products window 830, and the Target Products window 840 and individual attributes selected in the Accounts window 820, the user clicks a Generate button 851 in the Funds window 850.

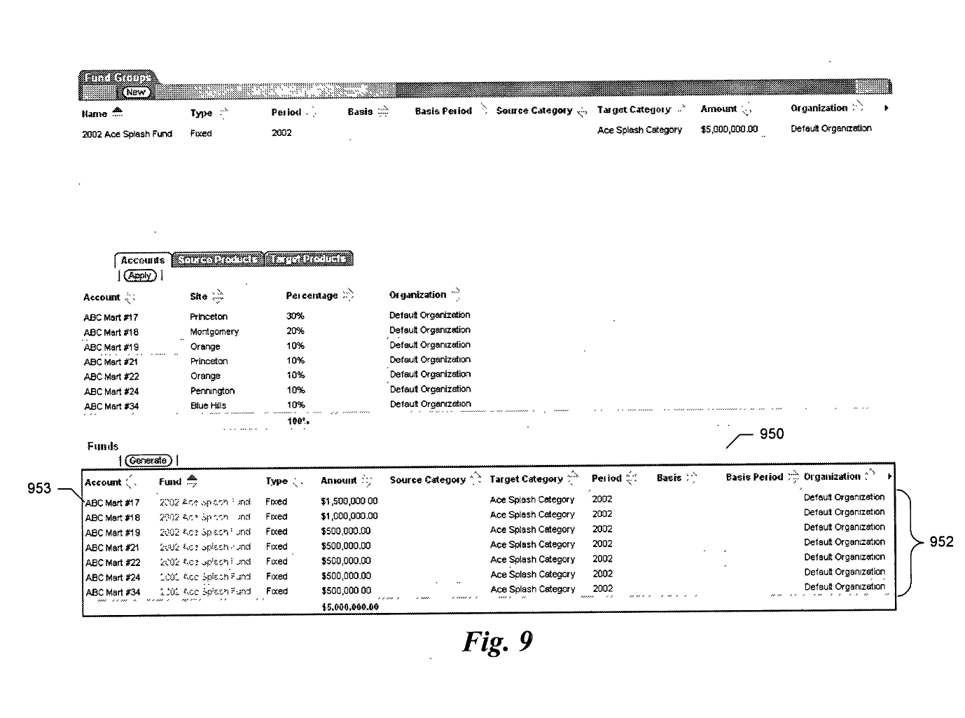

FIG. 9 is a display diagram showing funds automatically generated by the facility. The result of fund auto-generation is a list of fixed funds 952 for each retailer with the appropriate beginning amount. Each fund contains the information shown below in Table 2:

TABLE 2
1. Account - the retailer for whom the fund is created. During the auto-
generation process, the application refers to the list of retailers previously
added to the fund group to determine which retailers will receive funds.
2. Fund - the name of the auto-generated fund. During the auto-
generation process, this is automatically based on the name previously
specified for the fund group.
3. Type - the type of fund. During the auto-generation process, this is
automatically based on the type previously specified for the fund group.
4. Amount - the beginning amount of the fund. During the auto-generation
process, this is automatically calculated based on the fund group amount
and the percentage specified earlier for each retailer.
5. Target Category - the category of products for which the auto-generated
fund can be used. During the auto-generation process, this is
automatically based on the target category previously specified for the
fund group.
6. Period - the period over which the auto-generated fund is active. During
the auto-generation process, this is automatically based on the period
previously specified for the fund group.
7. Organization - the organization to which the fund belongs. During the
auto-generation process, this is automatically based on the organization
previously specified for the fund group.

After fixed funds are generated, the funds are available for usage within the software application, and additional users can view information about each fund. For example, other users can spend from the fund. (There are other views in the application that allow users to spend from the fund.) To view detailed information about a fund, such as Fund 953, the user selects the fund.

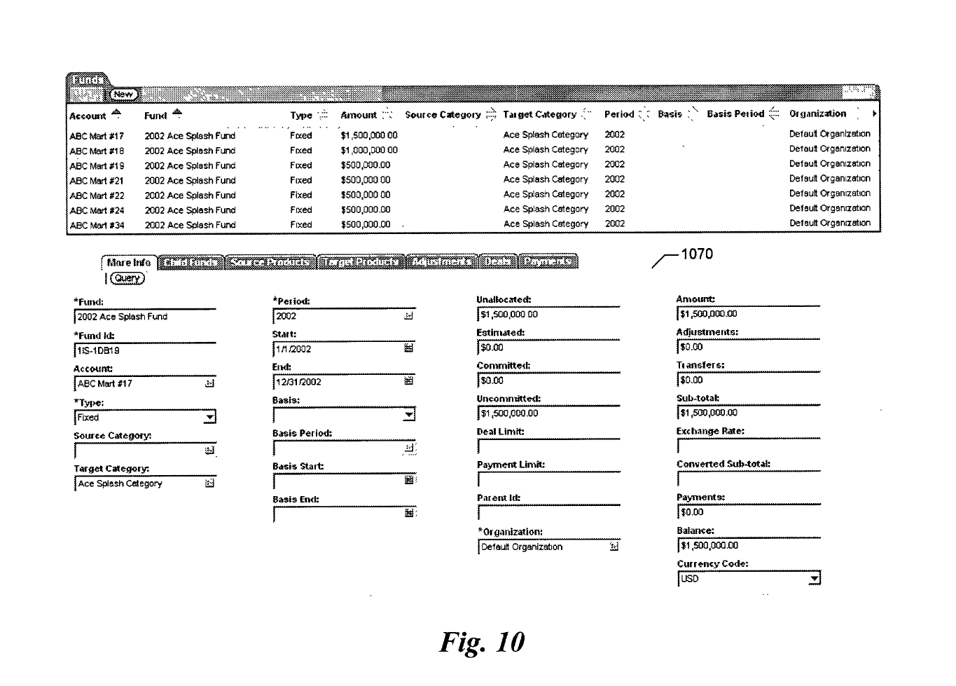

FIG. 10 is a display diagram showing additional detail on one of the created funds. It can be seen that a More Info window 1070 is displayed that contains additional information about selected fund 953. Over time, this view displays summary information relevant for the fund. For example, this view tracks the beginning amount, adjustments, transfers, payments, and balance of each fund.

In addition to or instead of creating fund groups made up of fixed funds where an initial fund group budget is distributed across all the funds in the fund group, in some embodiments, the facility enables users to create fund groups comprised of accrued funds in which money accrues over time based upon each retailer's performance, such as in selling the source product specified in the fund group. (In some embodiments, the facility may also create fund groups comprised of funds of a hybrid type that may receive initial funding, accrued funding, or both.)

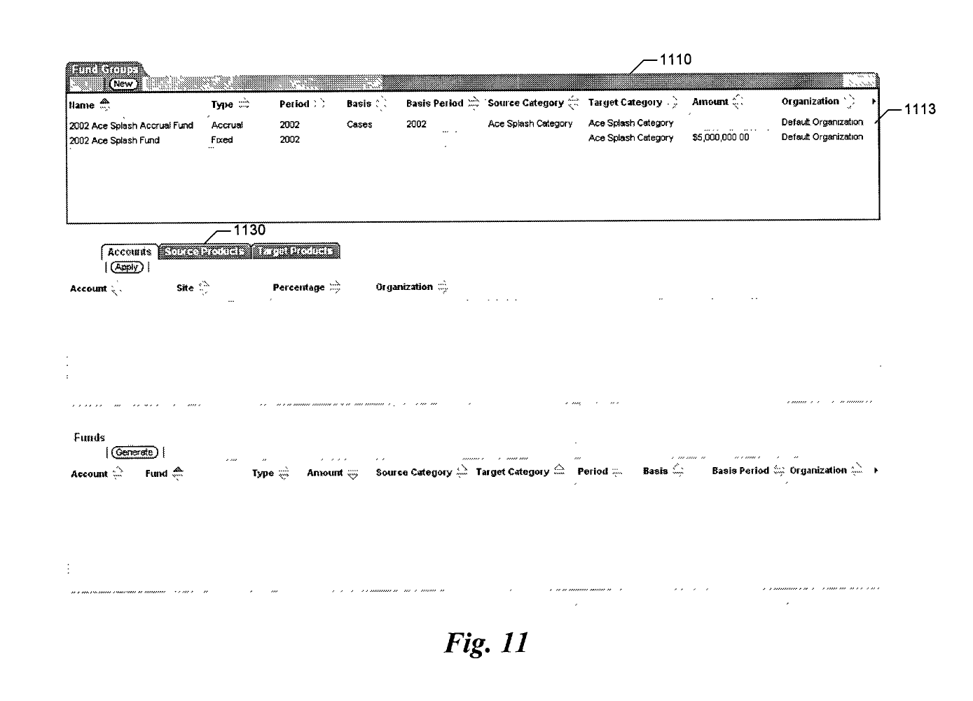

FIG. 11 is a display diagram showing the creation of an example fund group comprised of accrual funds. It can be seen that the user has added an accrual fund group 1113 to fund group window 1110. The user enters information for the fields shown below in Table 3. Information entered in the fund group will be propagated directly to the auto-generated funds or otherwise used during the auto-generation process.

TABLE 3
1. Name - the name of the fund group. In this example, the user enters
‘2002 Ace Splash Accrual Fund’
2. Type - the type of fund group. In this example, the user selects
‘Accrual’ to specify that the auto-generated funds will derive its
beginning balance from future activities performed by the retailers.
3. Period - the period over which the auto-generated funds is active. In
this example, the user selects ‘2002’
4. Basis - the unit used to accrue money to the fund. In this example, the
user selects ‘Cases’
5. Basis Period - the period over which the fund can accrue
6. Source Category - the category of products for which the auto-
generated funds use for calculating accruals. In this example, the user
selects ‘Ace Splash Category’.
7. Target Category - the category of products for which the auto-generated
funds can be used for. In this example, the user selects ‘Ace Splash
Category’.
8. Amount - null for accrual fund group because the amount of each fund
will be based on future activities performed by the retailers.
9. Organization - the organization to which the auto-generated funds
belong. In this example, the user selects ‘Default Organization’.

Next, the user adds source products to the fund group. This process is linked to the source category she previously selected for the fund group. To navigate to the view where source products are added, the user clicks on the tab of the Source Products window 1130.

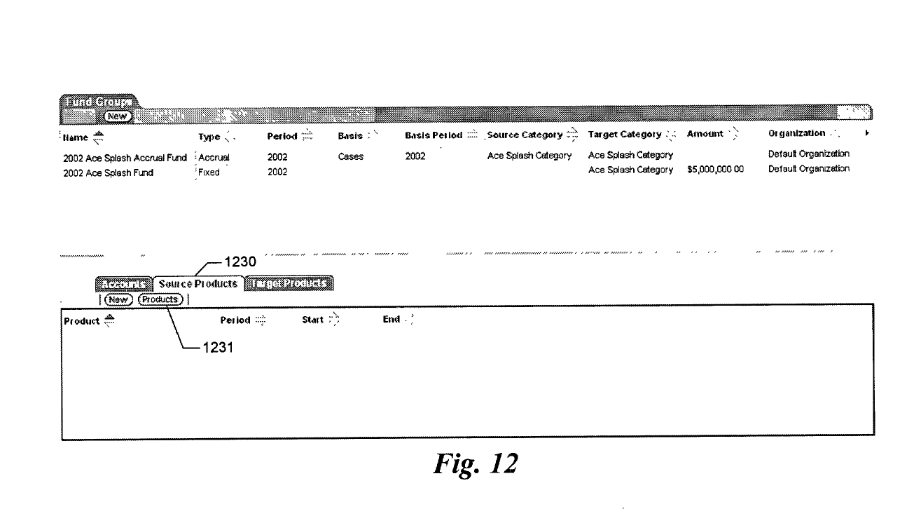

FIG. 12 is a display diagram showing the selection of source products for the example fund group of accrual funds. In the Source Products window 1230, the user clicks a products button 1231 in order to populate the Source Products window with the products in the Ace Splash product category specified as the source category for the example fund group for accrual funds.

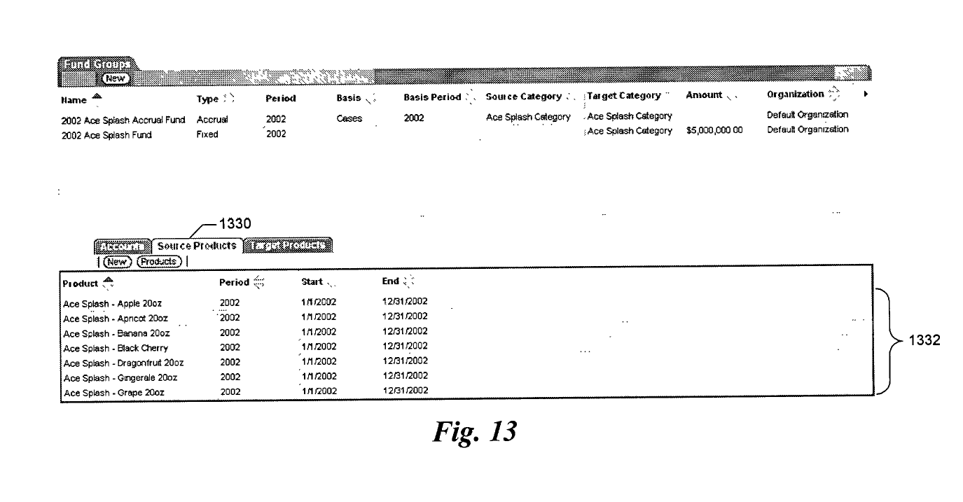

FIG. 13 is a display diagram showing source products for the accrual example fund group automatically populated from the source category specified for this fund group. It can be seen that the facility has added rows 1332, identifying individual products in the Ace Splash category, to the source products window 1330. The facility adds source products automatically by identifying all products that belong to the source category of the fund group. Specifically, the facility automatically adds all the products which belong to the source category and all products that belong to sub-categories of the source category. The facility can traverse an n-tier hierarchy to identify and add source products. Additionally, the user can also manually add one or more source products. The application ensures that duplicate products are not added.

For the accrual example fund group, the user proceeds to specify target products and accounts as discussed above in conjunction with FIGS. 4-8. At this point, the user can click the generate button in the Funds window to generate accrual funds in the example accrual fund group.

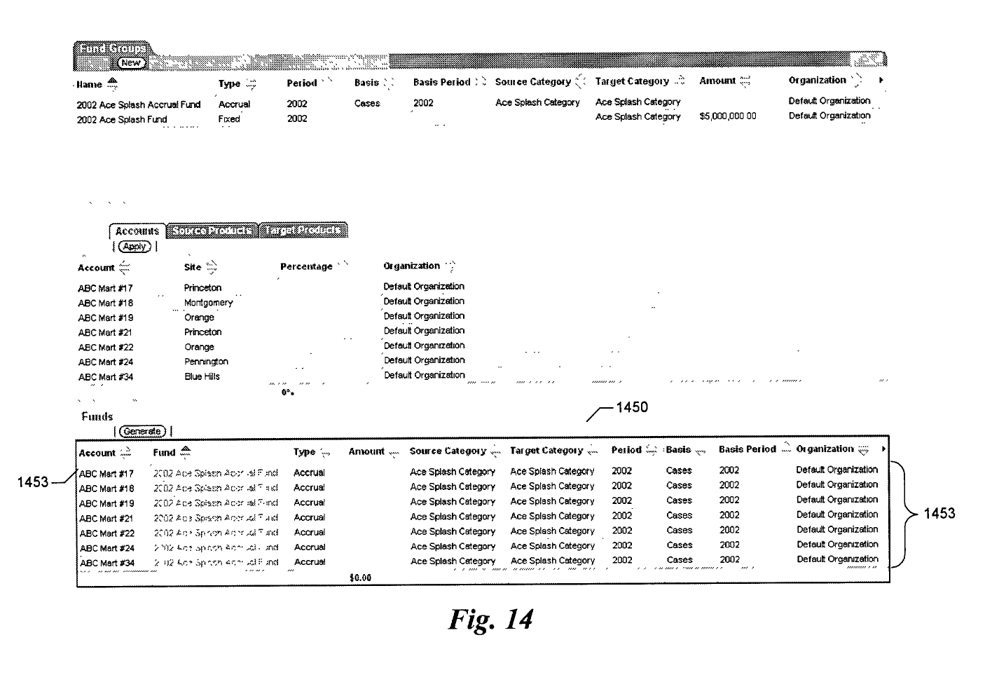

FIG. 14 is a display diagram showing the generation of sample accrual funds using the example accrual fund group. It can be seen that the facility has added rows 1453, each corresponding to a generated accrual fund, to the funds window 1450.

Each fund contains the information shown below in Table 4:

TABLE 4
1. Account - the retailer for whom the fund was created. During the auto-
generation process, the application refers to the list of retailers previously
added to the fund group to determine which retailers will receive funds.
2. Fund - the name of the auto-generated fund. During the auto-generation
process, this is automatically based on the name previously specified for
the fund group.
3. Type - the type of fund. During the auto-generation, this is auto-
matically based on type previously specified for the fund group.
4. Amount - the beginning amount of the fund. For accrual funds
generated, this is zero immediately after auto-generation.
5. Source Category - the category of products the auto-generated fund will
use for calculating accruals. During the auto-generation process, this is
automatically based on the source category previously specified for the
fund group.
6. Target Category - the category of products for which the auto-generated
fund can be used. During the auto-generation process, this is
automatically based on the target category previously specified for the
fund group.
7. Period - the period over which the auto-generated fund is active. During
the auto-generation process, this is automatically based on the period
previously specified for the fund group.
8. Basis - the unit used to accrue money to the fund. During the auto-
generation process, this is automatically based on the basis previously
specified for the fund group.
9. Basis Period - the period over which the fund can accrue. During the
auto-generation process, this is automatically based on the basis period
previously specified for the fund group.
10. Organization - the organization to which the fund belongs. During the
auto-generation process, this is automatically based on the organization
previously specified for the fund group.

Furthermore, the application propagates the source products and target products of the fund group to the auto-generated funds. This concludes the walk-through of the process to auto-generate accrual funds.

After accrual funds are generated, the funds are available within the software application for calculating accruals (thereby deriving its beginning balance) and for usage. For example, once there is money in the funds, other users can spend from the fund. (There are other views in the application that allow users to spend from the fund.) To view detailed fund information, such as fund 1453, the user selects the fund and drills down on the fund.

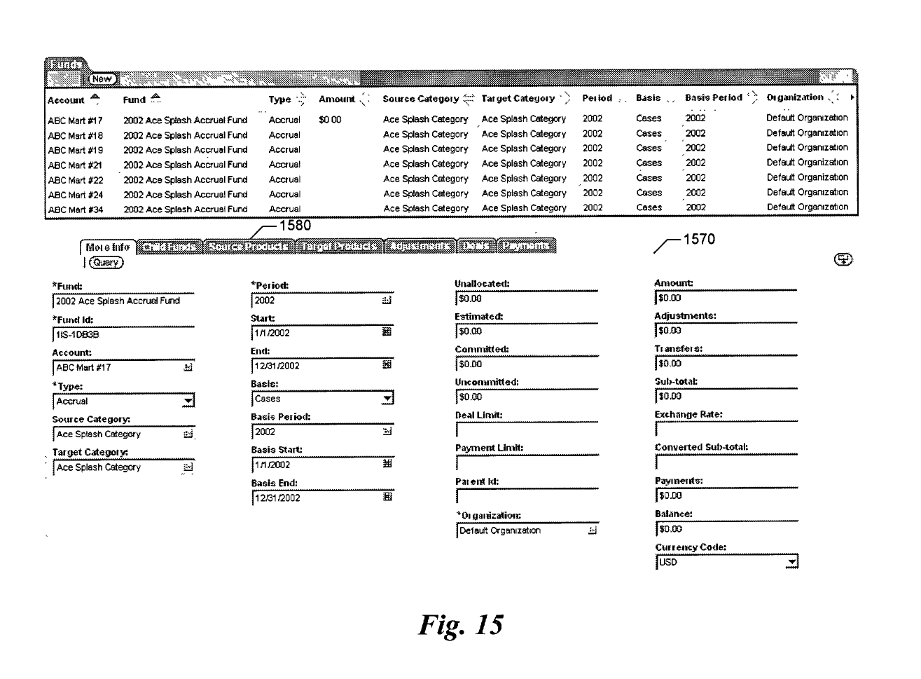

FIG. 15 is a display diagram showing additional detail on one of the created accrual funds. It can be seen that a More Info window 1570 is displayed that contains additional information about selected accrual fund 1453. Over time, this view displays summary information relevant for the accrual fund. For example, this view tracks the beginning amount, adjustments, transfers, payments, and balance of each accrual fund.

For accrual funds, the application also tracks accruals. To navigate to the view where accruals are calculated, the user clicks the tab for the Source Products window 1580.

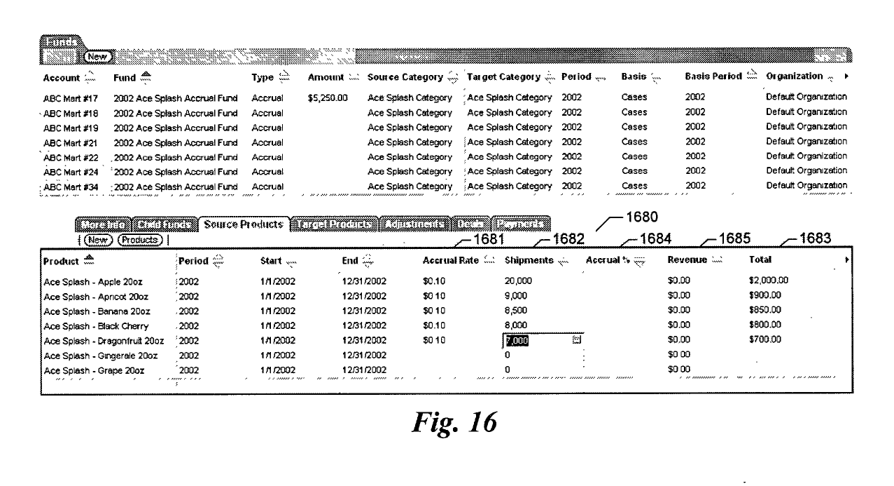

FIG. 16 is a display diagram showing additional details about the accrual of money in sample accrual funds. It can be seen that source products window 1680 contains: an Accrual Rate column 1681 indicating the amount of money that accrues for each shipment; a Shipments column 1682 indicating the number of shipments made to each account; and a Total column 1683 showing the total amount accrued for each account based upon the product of the Accrual Rate and Shipment columns. These columns are active for the sample accrual funds based on the selection of the accrual basis selected for this accrual fund group. Had the user instead selected an accrual basis which the amount accrued is based upon sales revenue, Accrual Percentage column 1684 and Revenue column 1685 would be multiplied to determine the total accrued amount shown in column 1683. The user can proceed to update the accrual rate and shipment information for each source product. Based on this information, the application tracks the accruals and updates the fund amount.

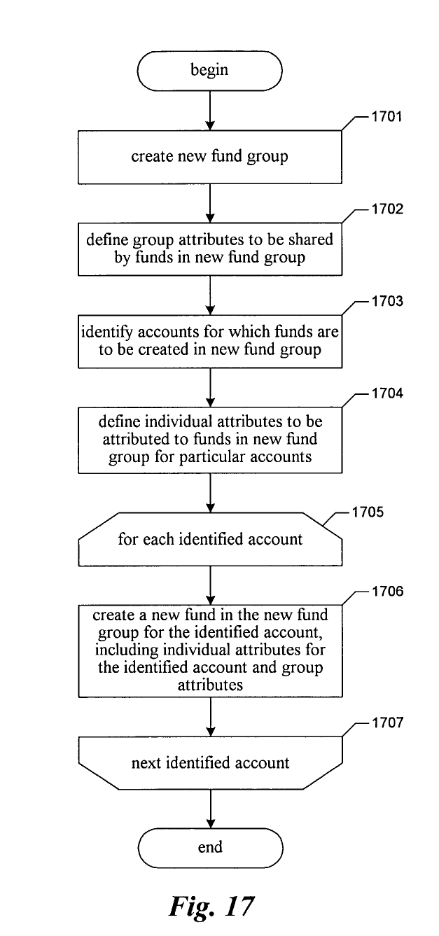

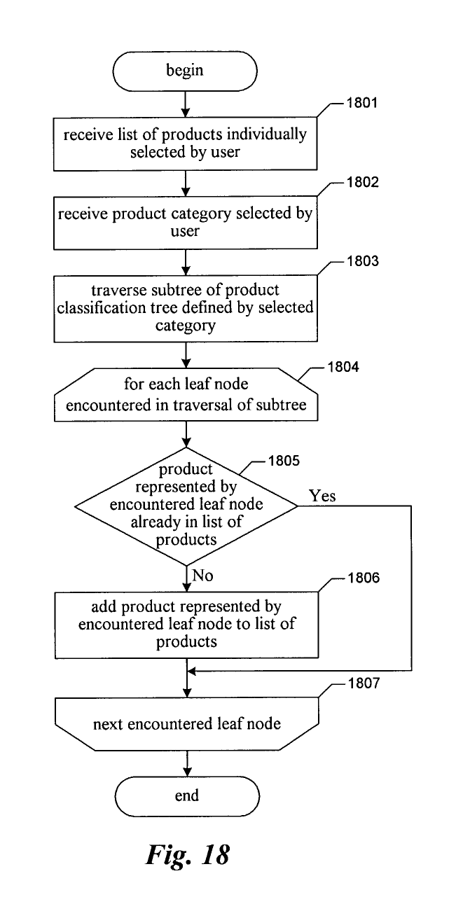

FIG. 17 is a flow diagram showing steps typically performed by the facility in order to create a number of new promotional funds. While FIG. 17 depicts a particular set of steps in a particular order, as does FIG. 18 discussed below, one of ordinary skill in the art will appreciate that various embodiments of the facility may perform variations on these sequences of steps, such as proper subsets or supersets of these steps, rearrangements of these steps, distribution of these steps over a number of different processors, etc.

In step 1701, in response to user input, the facility creates a new fund group, such as is depicted in the transition between FIG. 2 and FIG. 3. In step 1702, in response to user input, the facility defines group attributes to be shared by the funds in the new fund group, such as is shown in FIG. 5. For example, in various embodiments of the facility, the user may specify group attributes including a list of source products whose sale cause money to accrue in the funds of the fund group and target products on which money from funds in the fund group may be spent. As is discussed further below in conjunction with FIG. 18, in some embodiments the facility assists the user in specifying a list of source products or target products by populating the specified list with products falling under a product category in the manufacturer's product categorization tree selected by the user.

In step 1703, in response to user input, the facility identifies retailers or other accounts for which funds are to be created in the new fund group, such as is shown in FIG. 7. In step 1704, in response to user input, the facility defines individual attributes to be attributed to funds in the new fund group for particular accounts, such as is shown in FIG. 8. For example, the facility may define individual attributes for each account specifying the percentage of a total fixed budget for the fund group to be allocated to the account's fund. After step 1704, the facility loops through steps 1705-1707 for each account identified in step 1703. In step 1706, the facility creates a new fund in the new fund group for the current identified account which includes individual attributes for the current account, as well as group attributes shared among all accounts. In step 1707, if additional identified accounts remain to be processed, then the facility continues in step 1705 to process the next identified account, else these steps conclude.

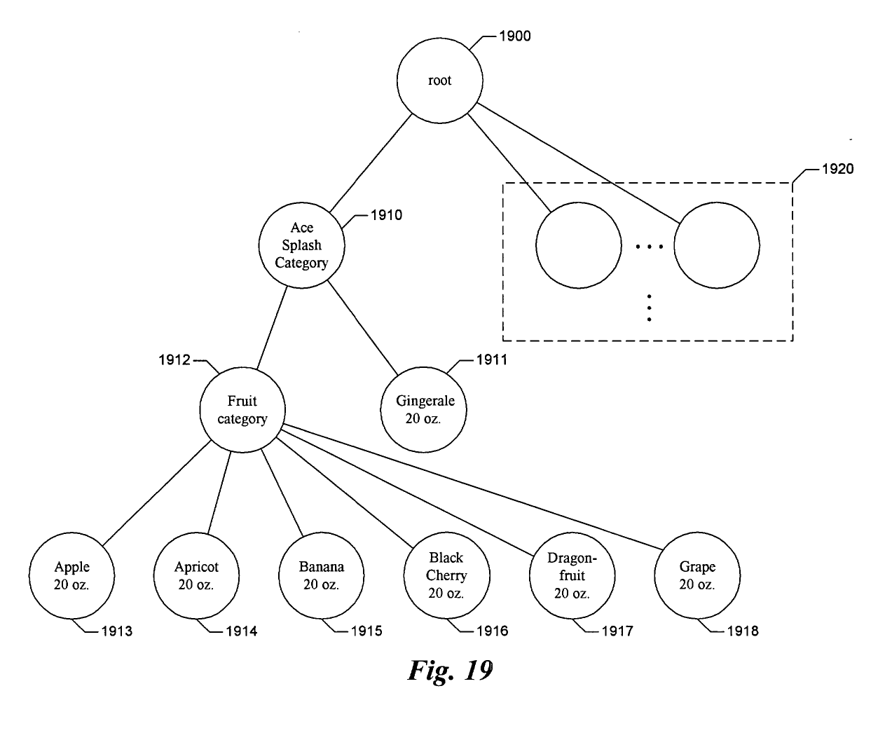

FIG. 18 is a flow diagram showing steps typically performed by the facility in order to display a list of products that includes the products comprising a user-selected product category. In step 1801, the facility receives a list of products individually selected by the user. For example, the user may type the names of these products or their product identifiers, or individually select products from a list of products. Alternatively, the user may not individually select any products. In step 1802, the facility receives a product category selected by the user. In step 1803, the facility identifies a node of the product classification tree used by the manufacturer to classify its products corresponding to the selected product category, and traverses the subtree of the product classification tree defined by the identified category node. In some embodiments, the traversal of step 1803 is performed in breadth-first order. The product categorization tree and its traversal are described in greater detail below in connection with FIG. 19.

After step 1803, the facility loops through steps 1804-1807 for each leaf node encountered in the subtree traversal of step 1803. In step 1805, if the product represented by the current encountered leaf node is already present in the list of products, then the facility continues in step 1807, else the facility continues in step 1806. In step 1806, the facility adds the product represented by the current encountered leaf node to the list of products. In step 1807, if additional leaf nodes encountered in the traversal of the subtree remain to be processed, then the facility continues in step 1804 to process the next leaf node, else these steps conclude.

In some embodiments, the facility performs steps 1805-1806 by querying a database table containing the products in the current list to determine whether it contains the product represented by the encountered leaf node. If so, the facility adds a row to this database table identifying the product represented by the encountered leaf node.

In some embodiments, the facility performs steps 1804-1807 by: generating a list of products represented by the leaf nodes encountered in traversing the subtree that is separate from the list of products received in step 1801—these two lists are referred to hereafter as the second list and the first list, respectively; traversing the sorted second list in order; and, for each product visited in the traversal of the sorted second list, traversing in the sorted first list to the first product whose product identifier is greater than or equal to the product identifier of the product visited in the traversal of the sorted second list, and if the product identifier of the traversed-to product in the sorted first list is greater than the product identifier of the product visited in the traversal of the sorted second list, inserting the product visited in the traversal of the sorted second list immediately before the traversed-to product in the sorted first list.

FIG. 19 is a data structure diagram showing a sample product categorization tree used by the facility to populate the target products window 540 with rows 543 based upon the user's selection of the Ace Splash category as the target category for the example fixed fund group. The tree is comprised of nodes, each having a parent node except for root node 1900. Each node not having any child nodes, e.g., nodes 1911 and 1913-1918, is called a “leaf node,” and represents a particular product. On the other hand, each node other than the root node having one or more children, e.g. nodes 1910 and 1912, is called a “non-leaf node,” and represents a product category. All of the products represented by leaf nodes that are descendants of a particular non-leaf node are considered to be part of the category represented by the non-leaf node. For example, a “Ginger Ale 20 oz.” product represented by node 1911 is considered to be part of the Ace Splash product category represented by node 1910, as node 1911 is a child of 1910. Similarly, an “Apple 20 oz.” product represented by node 1913 is considered to be part of both the Ace Splash product category represented by node 1910 and the Fruit category represented by node 1912, as node 1913 is a child of node 1912, which is a child of node 1910, and node 1913 is therefore a descendant of both node 1910 and node 1912.

As described above in conjunction with FIG. 18, in order to enumerate the products in the Ace Splash category, the facility selects the subtree of this product categorization tree defined by the node corresponding to the Ace Splash category, node 1910. (The subtree defined by a particular node is that node, together with all of its descendants.) The facility traverses this subtree, compiling a list of the products represented by the leaf nodes encountered as part of the traversal. In some embodiments, traversal is performed in breadth-first order. As an example, the facility may visit the nodes of the subtree in the following order: node 1910, node 1911, node 1912, node 1913, node 1914, node 1915, node 1916, node 1917, and node 1918. In doing so, the facility compiles the list of products shown in target products window 540.

Embodiments of the facility may be used by a wide variety of companies needing to manage promotional funds or other accounts for their customers. In addition to retailers, those customers can include virtually any other kind of business, such as a non-retail reseller, or a medical practice. Such customers may also include consumers: for example, an airline may use the facility in administering a frequent-flyer program for travelers.

It will be appreciated by those skilled in the art that the above-described facility may be straightforwardly adapted or extended in various ways. For example, any fund attribute may be specified either as a shared attribute attributed to all of the promotional funds created as part of a fund group, or as individual attributes attributed to individual promotional funds. While the foregoing description makes reference to preferred embodiments, the scope of the invention is defined solely by the claims that follow and the elements recited therein.

We claim:

1. A computer software product comprising a computer-readable medium whose contents cause a computing system to manage promotional funds by:
in response to a first user interaction, creating a plurality of promotional funds; and
in response to a second user interaction, processing a payment against a selected one of the created plurality of funds.

2. A method in a computing system for creating promotional funds for a purveyor of consumer goods, comprising:
receiving user input specifying fund attributes to be shared by promotional funds to be created; and
for each of a plurality of accounts of the purveyor, creating a promotional fund having the specified attributes.

3. The method of claim 2, further comprising:
receiving user input specifying, for each of at least a portion of the plurality of accounts, fund attributes to be attributed to the promotional fund for the account.

4. The method of claim 3 wherein the received user input specifying, for each of at least a portion of the plurality of accounts, fund attributes to be attributed to the promotional fund for the account specifies, for each such account, a fraction of a total amount to be allocated to the promotional fund for the account.

5. The method of claim 2, further comprising:
receiving user input selecting the plurality of accounts.

6. The method of claim 2 wherein the received user input specifying fund attributes to be shared by promotional funds to be created specifies one or more products whose purchase increases the amount of each of the created funds.

7. The method of claim 6 wherein the received user input specifying products whose purchase increases the amount of each of the created funds specifies those products by selecting a product category that comprises those products.

8. The method of claim 2 wherein the received user input specifying fund attributes to be shared by promotional funds to be created specifies one or more products for which amounts in each of the created funds may be disbursed to the account for which each promotional fund was created.

9. The method of claim 8 wherein the received user input specifying products for which amounts in each of the created funds may be disbursed specifies those products by selecting a product category that comprises those products.

10. A computing system for creating promotional funds for a purveyor of consumer goods, comprising:
an input subsystem that receives user input specifying fund attributes to be shared by promotional funds to be created; and
a creation subsystem creates a promotional fund having the specified attributes that for each of a plurality of accounts of the purveyor.

11. A method in a computing system for supplementing a first list of products with products in a selected product category, comprising:
accessing a product categorization tree in which each leaf node represents a product and every non-leaf node represents a product category;
in the product categorization tree, exhaustively traversing a subtree whose root is a node representing the selected product category; and
for each leaf node encountered during the traversal, adding the product represented by the leaf node to the first list of products if the first list of products does not already contain the product represented by the leaf node.

12. The method of claim 11 wherein the first list is stored as a database table in which each row of the table corresponds to a product in the first list, and wherein the adding comprises, for each leaf node encountered during the traversal:
querying the table to determine whether the table contains a row corresponding to the product represented by the leaf node;
adding a row to the table corresponding to the product represented by the leaf node only if it is determined that the table does not contain a row corresponding to the product represented by the leaf node.

13. The method of claim 11 wherein products are identified in the first list and in the product categorization tree by product identifiers, and wherein the adding comprises:
generating a second list containing the product identifiers of the products represented by the leaf nodes encountered during the traversal;
sorting the second list by product identifier;
sorting the first list by product identifier; and
merging the sorted second list into the sorted first list.

14. The method of claim 13 wherein the merging comprises:
traversing the sorted second list in order;
for each product visited in the traversal of the sorted second list:
traversing in the sorted first list to the first product whose product identifier is greater than or equal to the product identifier of the product visited in the traversal of the sorted second list; and
if the product identifier of the traversed-to product in the sorted first list is greater than the product identifier of the product visited in the traversal of the sorted second list, inserting the product visited in the traversal of the sorted second list immediately before the traversed-to product in the sorted first list.

15. The method of claim 11, further comprising storing the product categorization tree.

16. The method of claim 11 wherein each product in the first list of products is individually selected by a user.

17. The method of claim 11 wherein the traversal of the product categorization tree is a breadth-first traversal.

18. A computer-readable medium whose contents cause a computing system to supplement a first list of products with products in a selected product category by:
accessing a product categorization tree in which each leaf node represents a product and every non-leaf node represents a product category;
in the product categorization tree, exhaustively traversing a subtree descending from a node representing the selected product category; and
for each leaf node encountered during the traversal, adding the product represented by the leaf node to the first list of products if the first list of products does not already contain the product represented by the leaf node.
